(19) United States
(12) Patent Application Publication
(10) Pub. No.: US 2024/0217320 A1
(43) Pub. Date: Jul. 4, 2024

(54) VEHICLE GEAR DOOR

(71) Applicant: Rivian IP Holdings, LLC, Plymouth, MI (US)

(72) Inventors: David Wright McCall, Costa Mesa, CA (US); Stephen Mark Goodrich, Irvine, CA (US)

(21) Appl. No.: 18/176,093

(22) Filed: Feb. 28, 2023

Related U.S. Application Data
(60) Provisional application No. 63/477,918, filed on Dec. 30, 2022.

(51) Int. Cl. B60J 5/04; E05B 81/56; E05B 83/16

(52) U.S. Cl. CPC B60J 5/0473; B60J 5/0486; E05B 81/56; E05B 83/16

(57) ABSTRACT

An apparatus that can include a gear door. The gear door can be disposed at least partially between a rear wheel of a vehicle and a rear gate of the vehicle. The gear door can move from a closed position to an open position to provide access to an internal portion of the vehicle in the open position. The gear door can have a surface to support an object with the gear door in the open position.

### CROSS-REFERENCE TO RELATED PATENT APPLICATIONS

This application claims the benefit of and priority to U.S. Provisional Patent Application No. 63/477,918, filed on Dec. 30, 2022, the entirety of which is incorporated by reference herein.

### INTRODUCTION

Vehicles can have internal occupancy areas for people or other objects.

### SUMMARY

This disclosure is generally directed to an apparatus for a vehicle. The apparatus can include a gear door. The apparatus can be coupled with or included with the vehicle. The gear door can have at least one closed position and at least one open position. The gear door can enclose and provide access to an internal portion of the vehicle. The closed position of the gear door can enclose the internal portion of the vehicle. The internal portion of the vehicle can be accessed by at least one of a driver of the vehicle, an occupant of the vehicle or an operator of the apparatus. The internal portion of the vehicle can be accessible responsive to the gear door being moved from the closed position to the open position.

At least one aspect is directed to an apparatus. The apparatus can include a gear door. The gear door can be disposed at least partially between a rear wheel of a vehicle and a rear gate of the vehicle. The gear door can move from a closed position to an open position to provide access to an internal portion of the vehicle in the open position. The gear door can have a surface. The surface can support an object with the gear door in the open position.

At least one aspect is directed to a vehicle. The vehicle can include a rear wheel. The vehicle can include a rear gate. The vehicle can include an apparatus. The apparatus can include a gear door. The gear door can be disposed at least partially between the rear wheel of the vehicle and the rear gate of the vehicle. The gear door can move from a closed position to an open position to provide access to an internal portion of the vehicle in the open position. The gear door can have a surface. The surface can support an object with the gear door in the open position.

At least one aspect is directed to a method. The method can include providing an apparatus. The apparatus can include a gear door. The method can also include disposing the gear door, at least partially, between a rear wheel of a vehicle and a rear gate of the vehicle. The gear door can be configured to move from a closed position to an open position. The gear door can have a surface. The surface can support an object with the gear door in the open position.

At least one aspect is directed to a method. The method can include providing an apparatus. The apparatus can include a gear door. The gear door can have a surface to support an object.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an electric vehicle.

FIG. 2 depicts a rear view of a vehicle, in accordance with an implementation.

FIG. 3 depicts a side view of the vehicle illustrated in FIG. 2, in accordance with an implementation.

FIG. 4 depicts a rear view of the vehicle illustrated in FIG. 2, in accordance with an implementation.

FIG. 5 depicts a side view of the vehicle illustrated in FIG. 2, in accordance with an implementation.

FIG. 6 depicts a rear view of the vehicle illustrated in FIG. 2, in accordance with an implementation.

FIG. 7 depicts a rear view of the vehicle illustrated in FIG. 2, in accordance with an implementation.

FIG. 8 depicts an aerial view of the vehicle illustrated in FIG. 2, in accordance with an implementation.

FIG. 9 depicts a side view of the vehicle illustrated in FIG. 2, in accordance with an implementation.

FIG. 10 depicts an example system to control an apparatus, in accordance with an implementation.

FIG. 11 depicts an example flow diagram of a process to provide an apparatus, in accordance with an implementation.

FIG. 12 depicts an example flow diagram of a process to provide an apparatus, in accordance with an implementation.

FIG. 13 is a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems of a vehicle gear door. The various concepts introduced above and discussed in greater detail below may be implemented in any of numerous ways.

The present disclosure is directed to systems and methods of providing an apparatus. The apparatus can include a gear door. Vehicles can include storage compartments (e.g., an internal portion of the vehicle). The storage compartments can hold, keep, maintain or otherwise store components. For example, the storage compartment can be the trunk of the vehicle and the trunk can store ski equipment. The storage compartments can have limited space and the limited space can be used to store the components. Such limited space can hinder the ability for an operator, a passenger or other person associated with the vehicle to have a place to sit while also having access to the components stored in the storage component.

Systems and methods of the present technical solution can provide an apparatus that can provide access to the internal portion of the vehicle and also provide a support structure for an object. The apparatus can include a gear door. The apparatus can be coupled with or included with the vehicle. The gear door can have at least one closed position and at least one open position. The gear door can enclose and provide access to an internal portion of the vehicle. The closed position of the gear door can enclose the internal portion of the vehicle. The internal portion of the vehicle can be accessed by at least one of a driver of the vehicle, an occupant of the vehicle or an operator of the apparatus. The internal portion of the vehicle can be accessible responsive to the gear door being moved from the closed position to the open position.

The disclosed solutions have a technical advantage of providing access to the internal portion of the vehicle while also providing a surface to support an object. For example, the gear door can support a person. The person being supported by the gear door can also have access to the internal portion of the vehicle. The gear door allows for the person to sit and have access to their gear without first having to remove the gear from the vehicle. Additionally, the gear door can provide access to an external portion of the vehicle. For example, the gear door can be used as step stool and the person can stand on the gear door to gain access to gear that can be stored on the external of the vehicle (e.g., a roof rack).

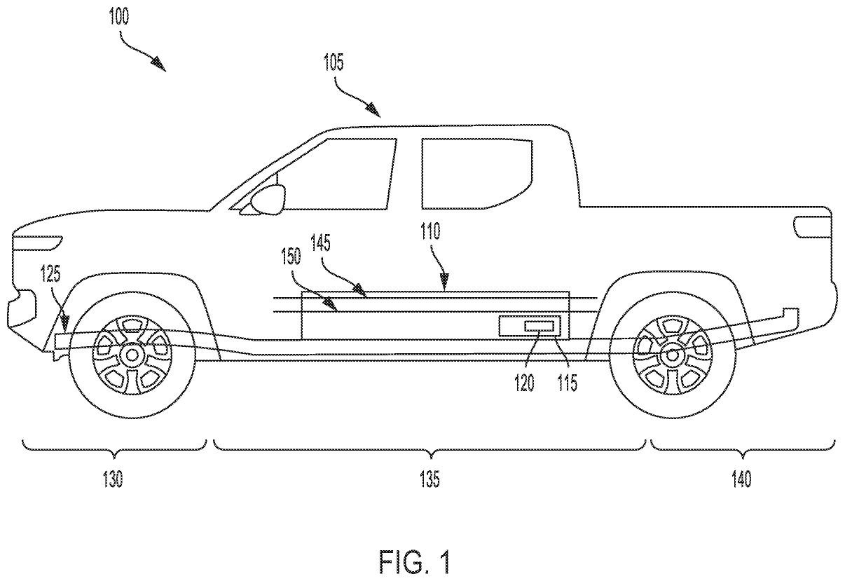

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115 or battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, the battery modules 115, or the battery cells 120 with other electrical components of the electric vehicle 105 to provide electrical power to various systems or components of the electric vehicle 105.

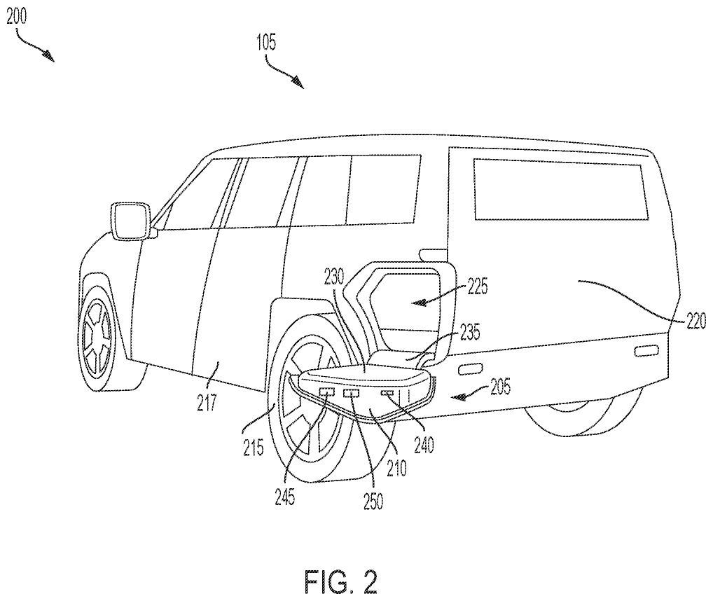

FIG. 2 depicts a rear view 200 of the vehicle 105. The vehicle 105 can be at least one of an SUV, a truck, a van, a minivan or a sedan. FIG. 2 depicts an example of the vehicle 105 as an SUV. The vehicle 105 can include at least one apparatus 205, at least one rear wheel 215, at least one passenger door 217, at least one rear gate 220 and at least one internal portion 225. The passenger door 217 can be a rear passenger door. The rear wheel 215 can be a wheel that is positioned between the passenger door 217 and the rear gate 220. The rear gate 220 can be or include at least one of a liftgate, a tailgate, a rear door, a panel or a hatch. The rear gate 220 can have at least one split configuration. The split configuration of the rear gate 220 can include the rear gate 220 having at least one portion that opens, closes or operates in a way that is different from a way that a second portion of the rear gate 220 opens, closes or operates. For example, the rear gate 220 can have a first portion that opens, closes or operates similar to that of a tailgate, and the rear gate 220 can have a second portion that opens, closes or operates similar to that of a liftgate. The rear gate 220 can have at least one closed position (e.g., a first position) and at least one open position (e.g., a second position). The internal portion 225 can be or include at least one of a cabin, a trunk, a storage area or a storage compartment. The apparatus 205 can be mounted, attached, placed, secured or coupled with the vehicle 105 or a portion thereof. The apparatus 205 can include at least one gear door 210 and at least one arm 235. The gear door 210 can include at least one surface 230, at least one rotating mechanism 245 and at least one adjusting mechanism 250. The gear door 210 can be placed, located, positioned, situated, stationed or otherwise disposed, at least partially, between the rear wheel 215 and the rear gate 220.

The gear door 210 can include at least one closed position and at least one open position. The gear door 210 can move from the closed position to the open position. For example, an operator of the apparatus 205 or the gear door 210 can grab, interface with, interact with or otherwise make contact with the gear door 210. The operator, while making contact with the gear door 210 and by providing force to the gear door 210, can move the gear door 210 from the closed position to the open position. For example, the gear door 210 can move similarly to that of a car door (e.g., the rear passenger door 217). The operator can also move the gear door 210 from the open position to the closed position. FIG. 2 depicts an example of the gear door 210 disposed at least partially between the rear wheel 215 and the rear gate 220, an example of the gear door 210 having been located, placed, positioned or moved from the closed position to the open position, an example of the rear gate 220 as a liftgate, and an example of the rear gate 220 in the closed position.

The gear door 210 can provide access to the internal portion 225 of the vehicle 105. The gear door 210 can provide access to the internal portion 225 by creating, presenting or otherwise providing an opening to the vehicle 105 or the internal portion 225. FIG. 2 depicts an example of the gear door 210 providing access to the trunk (e.g., the internal portion 225) of the vehicle 105. The surface 230 can support at least one object. For example, the surface 230 can support an operator of the gear door 210. The surface 230 can support the operator by holding, assisting, bracing, carrying or otherwise maintaining the position of the operator. For example, the surface 230 can hold the operator in a seated position (e.g., the operator can sit on the surface 230 and the surface 230 will hold the operator) or the surface 230 can support the operator in a standing position (e.g., the operator can stand on the surface 230 to facilitate easier access to a roof area of the vehicle).

The arm 235 can be mounted, attached, placed, secured or coupled with the vehicle 105 or a portion thereof. The arm 235 can couple the gear door 210 with the vehicle 105. The arm 235 can move the gear door 210. For example, the arm 235 can move the gear door 210 from the closed position to the open position. The arm 235 can be or include a hinge. The arm 235 can move the gear door 210 by adjusting, rotating, shifting, swiveling, turning or otherwise pivoting the gear door 210. For example, the arm 235 can move the gear door 210 by pivoting the gear door 210 from the closed position to the open position. The arm 235 can be designed, shaped, positioned, orientated or otherwise constructed to prevent the gear door 210 from making contact with an external portion of the vehicle 105. For example, the arm 235 can be or include a curve shape and the shape of the arm 235 can prevent the gear door 210 from making contact with the external portion of the vehicle 105 with the gear door 210 in the open position.

The arm 235 can move the gear door from the closed position to the open position and the shape of the arm 235 can position the gear door 210 away from the vehicle 105 or the external portion of the vehicle 105. The arm 235 positioning the gear door away from the vehicle 105 allows for the arm 235 to prevent the gear door 210 from making contact with the external portion of the vehicle 105. FIG. 2 depicts an example curved shape of the arm 235.

The apparatus 205 can include at least one locking mechanism 240. The locking mechanism 240 can be or include at least one of a latch, a switch, a lever, a slide, a clasp, a bolt, a bar, a clip or a lock. The locking mechanism 240 can be mounted, attached, placed, secured or coupled with the gear door 210. The locking mechanism 240 can hold, secure, maintain or otherwise lock the gear door 210 in the closed position. For example, the locking mechanism 240 can lock the gear door 210 similar to a lock on a vehicle door (e.g., the rear passenger door 217). The locking mechanism 240 can have at least one closed position (e.g., a first position) and at least one open position (e.g., a second position). The first position can lock the gear door 210 in the closed position. The second position allows for the gear door 210 to move from the closed position to the open position.

The locking mechanism 240 can actuate from the first position to the second position. For example, the gear door 210 can include a handle. The handle can actuate the locking mechanism 240 from the first position to the second position. An operator of the apparatus 205 or the gear door 210 can interact with, interface with or otherwise grab the handle to actuate the locking mechanism 240. The gear door 210 can, responsive to the actuation of the locking mechanism 240 from the first position to the second position, move from the closed position to an intermediate position (e.g., a third position). The third position can be a transitional position where the gear door 210 has moved from the closed position but the operator of the gear door 210 has yet to place the gear door 210 in the open position. The gear door 210 can move from the third position, responsive to an external force (e.g., the operator of the gear door 210 moving the gear door 210), to the open position.

The rotating mechanism 245 can be mounted, attached, placed, secured or otherwise coupled with the surface 230. The rotating mechanism 245 can be or include at least one of a hinge, a pivot, a swivel or a joint. The rotating mechanism 245 can rotate at least one of the gear door 210 or the surface 230 from a first position to a second position. For example, the rotating mechanism 245 can rotate the surface 230. The rotating mechanism 245 can rotate the surface 230 by adjusting, moving, altering, modifying or otherwise changing the position of the surface 230. The rotating mechanism 245 can be or include at least one of a piston, a mechanical latch, a button, a spring, a pull knob or a bar. An operator of the apparatus 205 or the rotating mechanism 245 can interface with, interact with or otherwise engage the rotating mechanism 245. For example, the operator of the rotating mechanism 245 can push a button, on the rotating mechanism 245, to enable the operator to rotate, with the rotating mechanism 245, the surface 230. The operator engaging the button can lock or unlock the rotating mechanism 245. For example, the rotating mechanism 245 can be prevented from rotating prior to the button being pressed.

The rotating mechanism 245 can rotate about a vertical axis (e.g., an axis that is perpendicular to the axis that the arm 235 rotates about) towards a center line of the vehicle 105. For example, a portion of the surface 230, with the gear door 210 in the open position, can be further away from the body of the vehicle 105 than a portion of the apparatus 205, and the surface 230 can be moved closer, responsive to the rotating mechanism 245 rotating the surface 230 about the vertical axis, to the body of the vehicle 105. The rotating mechanism 245 can move the surface 230, about the vertical axis, towards the front of the vehicle 105 (e.g., away from the rear gate 220) or the rotating mechanism 245 can move the surface 230, about the vertical axis, towards the rear of the vehicle 105. The rotating mechanism 245 can provide, by moving the surface 230 towards to the front of the vehicle, improved access to the internal portion 225 as the surface 230 has been moved further away from the internal portion 225. The rotating mechanism 245 can provide, by moving the surface 230 towards the rear of vehicle 105, an operator being supporting by the surface 230 an improved interface with an operator that is being supporting by a second surface 230 of a second gear door 210 disposed on the opposite of the vehicle 105.

The rotating mechanism 245 can provide additional space for the surface 230. For example, the vehicle 105 can be positioned near an obstacle (e.g., a vehicle, a tree, a building) and the obstacle can encroach or can be very close to the vehicle 105 or a component thereof. The apparatus 205 can be positioned close to the obstacle. The surface 230, with the gear door 210 in the open position, can have a first position. The first position can include a first distance from the obstacle. The rotating mechanism 245 can rotate the surface 230 from the first position to the second position. The second position can include a second distance from the obstacle. The second distance can be larger than, smaller than or equal to the first distance. For example, the second distance can be larger than the first distance. The second distance being larger than the first distance can provide additional space between the surface 230 and the obstacle as the second distance is further away from the obstacle. FIG. 2 depicts an example of the surface 230 in the first position.

The adjusting mechanism 250 can be mounted, attached, placed, secured or coupled with the surface 230. The adjusting mechanism 250 can be or include at least one of a motor, a piston or a hydraulic. The adjusting mechanism 250 can adjust the surface 230 from a first height to a second height. The operator of the vehicle 105 or the apparatus 205 can interface with, interact with or otherwise engage with the adjusting mechanism 250. For example, the adjusting mechanism 250 can include a button, and the operator can engage with the adjusting mechanism 250 by pressing the button. The operator pressing the button can cause the adjusting mechanism to adjust the height of the surface 230. The first height and the second height can indicate a distance between the surface 230 and a ground surface. The ground surface can be or include at least one of a road, a dirt road, an off-road, an interstate, a parking lot surface, the earth or any other possible surface or terrain. The adjusting mechanism 250 can adjust the surface 230 from the first height to the second height by lifting, raising, elevating, lowering, descending or otherwise changing the height of the height of the surface 230. The adjusting mechanism 250 adjusting the height of the surface 230 can provide, to an operator of the gear door 210 or the apparatus 205, the ability to customize the distance between the surface 230 and the ground surface. The customization of the distance between the surface 230 and the ground surface allows for the surface 230 or the gear door 210 to provide additional support to the operator. For example, a first operator can have a first height (e.g., five feet tall) and a second operator can have a first height (e.g., six feet tall). The first operator, while being supported by the surface 230 at the first height, can have difficulty making contact with the ground surface. For example, the first operator's feet may dangle (e.g., not make contact with the ground surface) while sitting on the surface 230 at the first height. The adjusting mechanism 250 can lower the surface 230 from the first height to the second height. The lowering of the surface 230 can allow for the first operator's feet to easily make contact with the ground surface.

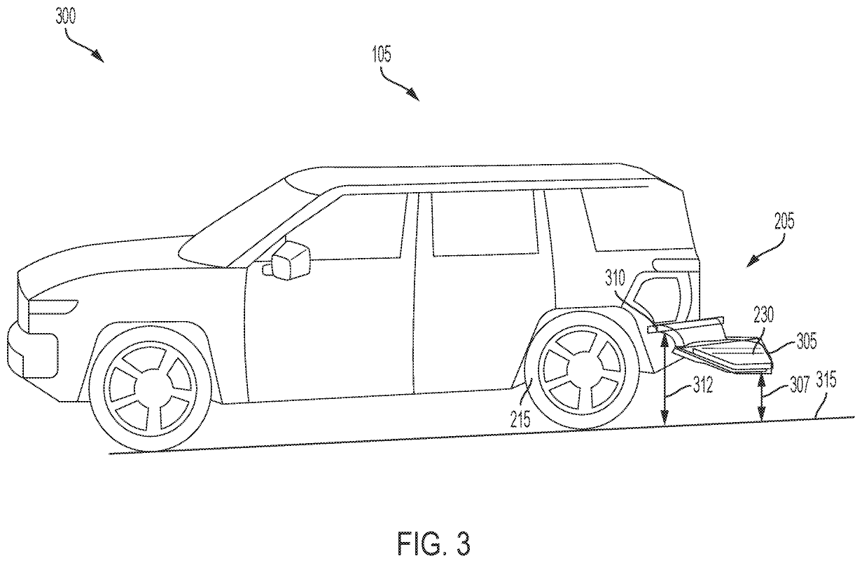

FIG. 3 depicts a side view 300 of the vehicle 105. The vehicle 105 can include the apparatus 205. The vehicle 105 or a portion there of can make contact with a ground surface 315 (e.g., the ground surface described herein). For example the rear wheel 215 can make contact or touch the ground surface 315. The apparatus 205 can include at least one first portion 305 and at least one second portion 310. The first portion 305 can include the surface 230. The first portion 305 can have a first distance 307. The first distance 307 can indicate a distance, a length, a height or an amount of space between the first portion 305 and the ground surface 315. The second portion 310 can be mounted, attached, placed, secured or coupled with the vehicle 105 or a portion thereof. The second portion 310 can include a second distance 312. The second distance 312 can indicate a distance, a length, a height or an amount of space between the second portion 310 and the ground surface 315. The first distance 307 can be larger than, smaller than or equal to the second distance 312. The second distance 312 can be larger than, smaller than or equal to the first distance 312. For example, the first distance 307 can be smaller than the second distance 312. The first distance 307 being smaller than the second distance 312 can indicate that the first portion 305, in relation to the second portion 310, is closer to the ground surface 315.

The value of the first distance 307 or the value of the second distance 312 can change, adjust or otherwise be modified based on the position of the gear door 210. For example, the first distance 307 can have a first value with the gear door 210 in the closed position and the first distance 307 can have a second value with the gear door 210 in the closed position. The position or location of the first portion 305 or the second portion 310 can change with the position of the gear door 210. The changing of the location of the first portion 305 or the second portion 310 can adjust the value of the first distance 307 or the value of the second distance 312. For example, the first distance 307, with the gear door 210 in the open position, can be smaller than the second distance 312. The first distance 307, with the gear door 210 in the closed position, can be larger than the second distance 312. FIG. 3 depicts an example of the first distance 307 being smaller than the second distance 312 as the first portion 305 is closer to the ground surface 315.

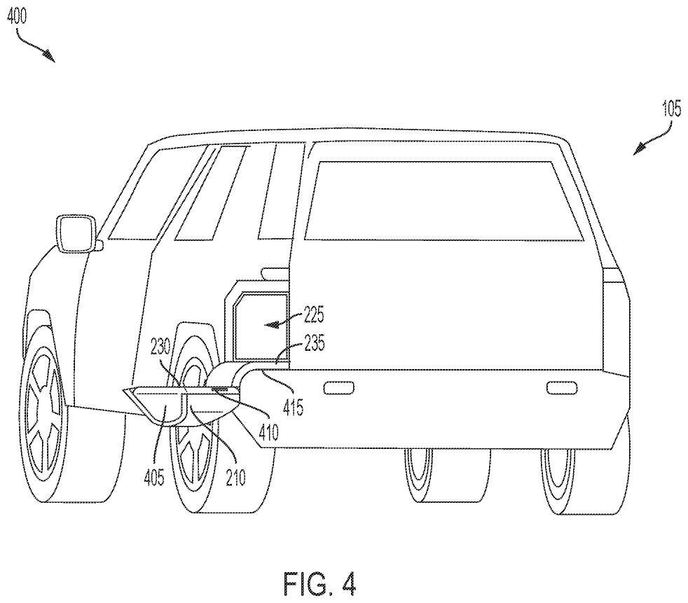

FIG. 4 depicts a rear view 400 of the vehicle 105. The vehicle 105 can include the gear door 210. The gear door 210 can include at least one housing 405. The housing 405 can be placed, located, positioned or otherwise disposed beneath the surface 230. The surface 230 can include at least one hinge 410. The hinge 410 can move the surface 230 from a first position (e.g., a closed position) to a second position (e.g., an open position). The hinge 410 can move the surface 230 by adjusting, rotating, shifting, swiveling, turning or otherwise pivoting the surface 230 from the first position to the second position. The hinge 410 can move the surface 230 from the second position to the first position. The housing 405 can store at least one component. For example, the housing 405 can store at least one of a first-aid kit, vehicle accessories, or user accessories. The housing 405 can be covered, by the surface 230, with the surface 230 in the first position. The housing 405 can be accessible (e.g., not covered) with the surface 230 in the second position.

The vehicle 105 can include at least one structure 415. The structure 415 can be or include at least one of a rear bumper, a rear fender, a bar or a beam. FIG. 4 depicts the structure 415 as the rear bumper of the vehicle 105. The apparatus 205 or a portion thereof can rest on the structure 415. For example, the arm 235 can rest on the structure 415. FIG. 4 depicts an example of the arm 235 resting on the structure 415. The portion of the apparatus 205 resting on the structure 415 can define the open position of the gear door 210. For example, the arm 235 resting on the structure 415 can define the open position of the gear door 210 by holding, obstructing, blocking, hampering, hindering or otherwise preventing the gear door 210 from opening to a position that is beyond the position of gear door 210 with the arm 235 resting on the structure 415.

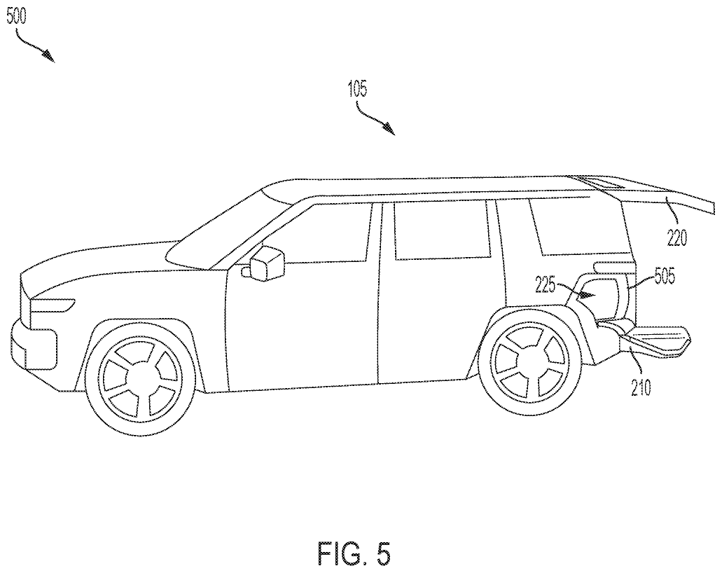

FIG. 5 depicts a side view 500 of the vehicle 105. FIG. 5 depicts an example of the gear door 210 having been placed in the open position and an example of the rear gate 220 in the open position. The apparatus 205 can include at least one structure 505. The structure 505 can be or include at least one of a bar, a beam, a strut, a brace or shaft. The structure 505 can provide support to the gear door 210 and the structure 505 can define the opening to the vehicle 105 or the internal portion 225 that is provided with the gear door 210 in the open position. The structure 505 can define the opening to the vehicle 105 or the internal portion 225 by establishing, separating, creating or otherwise dividing the internal portion 225 from the rear gate 220.

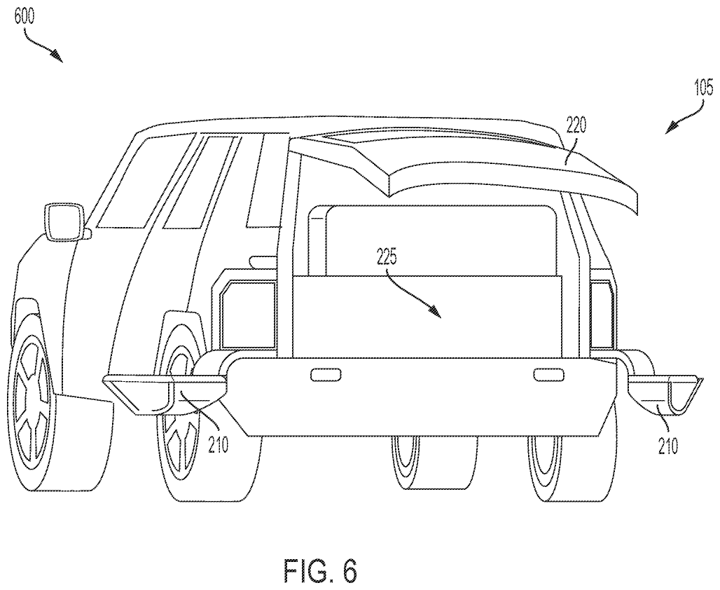

FIG. 6 depicts a rear view 600 of the vehicle 105. FIG. 6 depicts an example of the vehicle 105 having a first gear door 210 and a second gear door 210, an example of the first gear door 210 and the second gear door 210 having been placed in the open position, an example of the rear gate 220 having been placed in the opening position and an example of the internal portion 225 as the trunk of the vehicle 105.

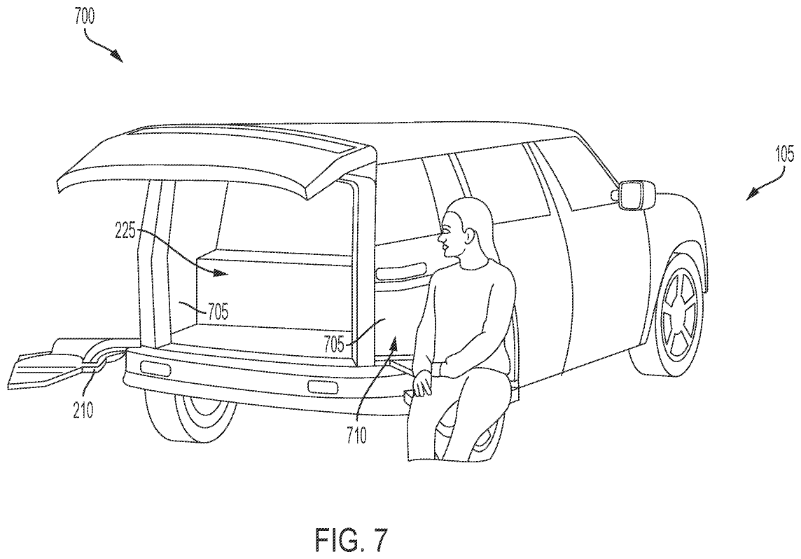

FIG. 7 depicts a rear view 700 of the vehicle 105. The apparatus 205 can include at least one partition 705. The partition 705 can be or include at least one of a wall, a barricade or a structure. The partition 705 can divide the internal portion 225. For example, the partition 705 can divide the internal portion 225 into a first portion and a second portion. The partition 705 and the gear door 210 can form at least one cavity 710. The cavity 710 can be or include a portion of the internal portion 225 that is divided by the partition 705. The cavity 710 can receive a component. For example, the cavity 710 can receive a backpack. The cavity 710 can also store the component. FIG. 7 depicts an example of the vehicle 105 including a first apparatus 205 and a second apparatus 205, an example of the first apparatus 205 and the second apparatus 205 including the partition 705 and an example of the partition 705 and the gear door 210 forming the cavity 710.

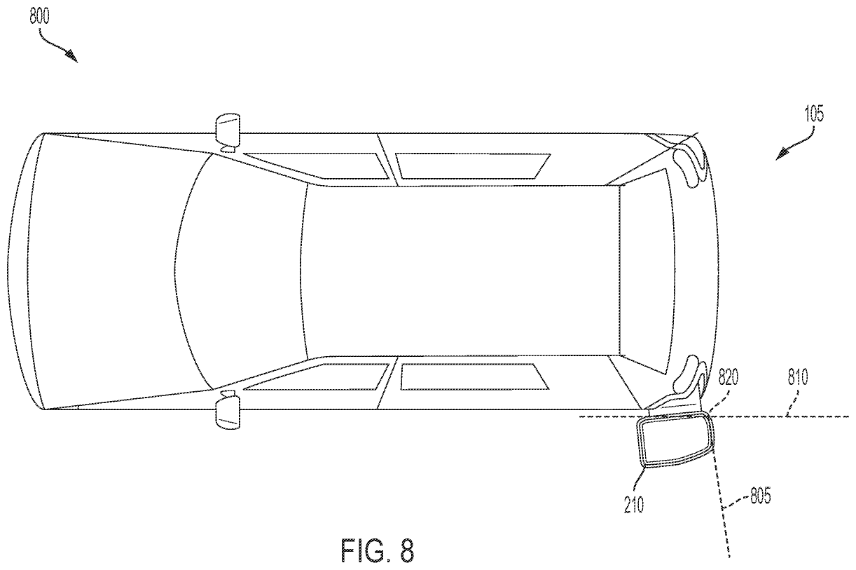

FIG. 8 depicts an aerial view 800 of the vehicle 105. The gear door 210 have at least one orientation 805. The orientation 805 can indicate at least one of a direction, a position, a location, a bearing or a placement of the gear door 210. The orientation 805 can be adjusted, modified or otherwise changed in relation to the position of the gear door 210. For example, the orientation 805 can have a first value with the gear door 210 in the closed position and the orientation 805 can have a second value with the gear door 210 in the open position. The vehicle 105 or a portion thereof can have at least one orientation 810. The orientation 810 can indicate at least one of a direction, a position, a location, a bearing or a placement of the vehicle 105 or a portion thereof. The orientation 805 and the orientation 810 can be different. The orientation 805 and the orientation 810 can define, at a point 820 where there intersect, an angle. The angle defined at the point 820 can be different than 90 degrees. For example, the orientation 805 and the orientation 810 can define an angle of 85 degrees. FIG. 8 depicts an example of the orientation 805 and the orientation 810 having different values and an example of the orientation 805 and the orientation 810 defining an angle that is different than 90 degrees.

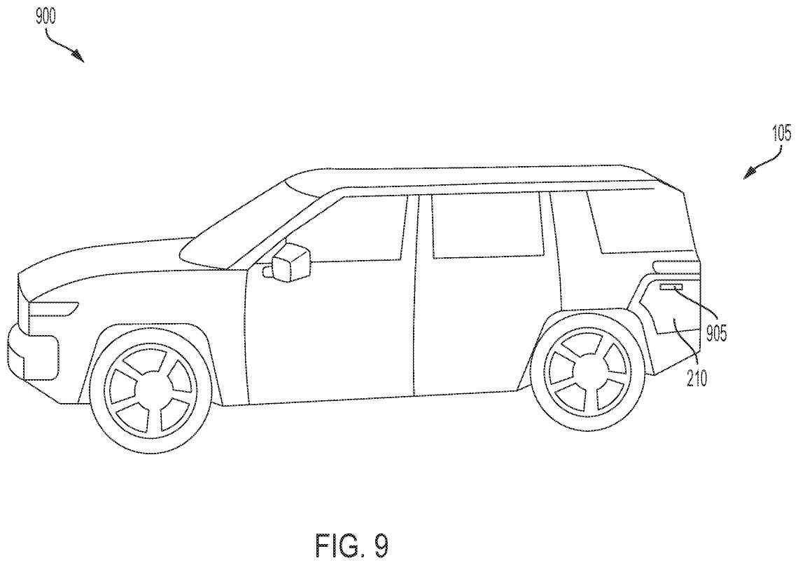

FIG. 9 depicts a side view 900 of the vehicle 105. The gear door 210 can include at least one handle 905. The handle 905 (e.g., the handle described herein) can be or include at least one of a spring, a piston, a lever, a bar or a shaft. The handle 905 can actuate the locking mechanism 240 from the first position to the second position. An operator of the apparatus 205 or the gear door 210 can interact with, interface with or otherwise grab the handle 905 to actuate the locking mechanism 240. The operator can, responsive to engaging the handle 905, move the gear door 210 from the closed positon to the open position. FIG. 9 depicts an example of the gear door 210 in the closed position.

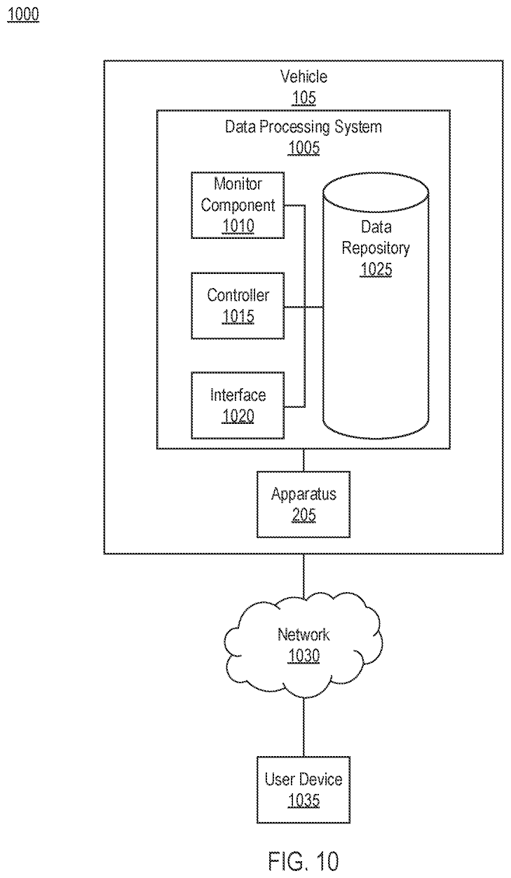

FIG. 10 depicts a system 1000 for controlling an apparatus. The apparatus can be the apparatus 205. The system 1000 can include the vehicle 105, at least one network 1030 and at least one user device 1035. The vehicle 105 can include at least one data processing system 1005 and the apparatus 205. The data processing system 1005 can include at least one monitor component 1010, at least one controller 1015, at least one interface 1020 and at least one data repository 1025. The data processing system 1005 or at least one component of the data processing system 1005 can be external to the vehicle 105. For example, the data processing system 1005 can be a remote server system (e.g., a cloud based data processing system) or a data processing system that is included in or stored on a user device (e.g., the user device 1040).

The monitor component 1010 can be or include at least one motion sensor. The motion sensor can collect data. The motion sensor can collect data that can be used to determine at least one of a position of the gear door 210 (e.g., open position or closed position), a position of the locking mechanism 240 (e.g., open position or closed position), a position of the surface 230 (e.g., first position or second position) or an interaction with the handle 905 (e.g., actuation of the locking mechanism 240). For example, the monitor component 1010 can determine that the gear door 210 is in the closed positioned.

The monitor component 1010 can be or include at least one interface sensor. The interface sensor can collect data that can be used to determine a selection on an interface. For example, the interface sensor can be a tactile sensor. The interface sensor can detect an operator of the apparatus 205 or the vehicle 105 selecting at least one option presented on a user interface. For example, an operator can select an option on a user interface, displayed by the interface 1020, to unlock the gear door 210 and the interface sensor can detect that the option to unlock the gear door 210 has been selected.

The interface 1020 can be or include at least one of a display device, a display screen, a user device, a monitor, an infotainment system of the vehicle 105 or a user device. The interface 1020 can display, provide, create, generate or otherwise present at least one user interface or at least one graphical user interface. The graphical user interface, presented by the interface 1020, can include at least one icon. For example, the interface can include an unlock gear door icon.

The data processing system 1005 and a user device 1035 can interface by using a network 1030. The user device 1035 can include at least one of a mobile phone, a smart watch, a tablet, a smart phone, an infotainment system of a vehicle (e.g., the infotainment system of the vehicle 105). An operator of the user device 1035 can perform similar operations to that performed by selecting icons on the interface 1020. For example, the user device 1035 can include an application that has been stored on the user device 1035 and is associated with the apparatus 205. For example, when an operator purchased the apparatus 205 or the vehicle 105 they received instructions of how to download the application and link the application with the apparatus 205 or the vehicle 105. An operator of the user device 1035 can select an icon on an interface of the user device 1035 to unlock the gear door 210.

The data repository 1025 can include, store, maintain or otherwise provide data. The data can be data that is collected and provided by the monitor component 1010, data that is collected and provided by the interface 1020 or data that is provided by the user device 1035.

The monitor component 1010 can receive, via the interface 1020, an indication to unlock the gear door 210. The indication can be an operator of the vehicle 105 or the apparatus 205 selecting an icon, displayed by the interface 1020, to unlock the gear door 210. For example, the monitor component 1010 can detect that an operator of the vehicle 105 has selecting the icon to unlock the gear door 210. The monitor component 1010 can, responsive to receiving the indication to unlock the gear door 210, determine the position of the locking mechanism 240. For example, the monitor component 1010 can determine that the locking mechanism 240 is in the closed position (e.g., the gear door 210 is locked).

The monitor component 1010 can, responsive to determining that the gear door 210 is locked, communicate with, interface with or otherwise interact with the controller 1015. The monitor component 1010 can provide, to the controller 1015, the indication to unlock the gear door 210. The controller 1015 can be mounted, attached, placed, secured or otherwise coupled with the apparatus 205 or a component thereof. The controller 1015 can be electrically coupled with the apparatus 205 or a component thereof. The controller 1015, responsive to receiving the indication to unlock the gear door 210, can communicate with, interface with or otherwise interact with the locking mechanism 240. For example, the controller 1015 can provide, to the locking mechanism, a signal that causing the locking mechanism 240 to move from the closed position to the open position (e.g., unlock the gear door 210). The unlocking of the gear door 210, responsive to the signal from the controller 1015, can cause at least a portion of the gear door 210 to move away from the vehicle 105. For example, the gear door 210 can move from the closed position to a transitional position.

The monitor component 1010 can detect a position of the gear door 210. For example, the monitor component 1010 can include a sensor that can detect the apparatus 205 making contact with or resting on at least one of the vehicle 105, a portion of the vehicle 105 or a component of the vehicle 105. The monitor component 1010 can compare the position of the gear door 210 with a predetermined position. For example, the data repository 1025 can store, hold, keep or otherwise maintain at least one predetermined position. The predetermined position can be or include at least one closed position and at least one open position. For example, the predetermined position can be the open position of the gear door 210 responsive to the apparatus 205 resting on the structure 415. The monitor component 1010 can determine that the position of the gear door 210 is not within predetermined position. For example, the monitor component 1010 can determine, responsive to determining that the arm 235 is not resting on the structure 415, that the gear door 210 has not been moved to the open position. The monitor component can, responsive to determining that the gear door 210 is not within the predetermined position, can communicate with, interact with or otherwise interface with the interface 1020.

The interface 1020 can receive, from the monitor component 1010, an indication that the gear door 210 is not within predetermined position. The interface 1020 can, responsive to receiving the indication, generate, create, provide or other present a user interface that includes an alert. The alert can include an indication of the position of the gear door 210. For example, the alert can include an indication that the gear door 210 is not in the open position.

The monitor component 1010 can receive, via the interface 1020, a request to lock the gear door 210. The request can be an operator of the vehicle 105 or the apparatus 205 selecting an icon, displayed on the interface 1020, to lock the gear door 210. The monitor component 1010 can, responsive to receiving the request to lock the gear door 210, determine the position of the gear door 210. For example, the monitor component 1010 can determine that the gear door 210 is in the open position. The monitor component 1010 can, responsive to determining the position of the gear door 210, communicate with, interface with or otherwise interact with the interface 1020.

The interface 1020 can receive, from the monitor component 1010, an indication that the gear door 210 is not in the closed position. The interface 1020 can, responsive to receiving the indication, generate, create, present or otherwise provide an interface. The interface can include an alert. The alert can indicate that the gear door 210 is not in the closed position. For example, the alert can include a text prompt that indicates that the gear door 210 is in the open position.

The monitor component 1010 can determine a second position of the gear door 210. The monitor component 1010 can determine, responsive to the operator of the vehicle 105 or the apparatus 205 providing an indication that the gear door 210 has been moved, the second position of the gear door 210. The monitor component 1010 can determine that the second position is the closed position. The monitor component 1010 can, responsive to determining that the second position is the closed position, communicate with, interact with or otherwise interface with the controller 1015.

The controller 1015 can receive, from the monitor component 1010, an indication to lock the gear door 210. The controller 1015 can provide, responsive to receiving the indication to lock the gear door 210, a signal, to the locking mechanism 240, that causes the locking mechanism 240 to actuate from the open position to the closed position. The actuation of the locking mechanism 240 from the open position to the closed positon can lock the gear door 210 in the closed position.

The monitor component 1010, can determine a position of the surface 230. For example, the monitor component 1010 can include a sensor that can detect that the surface 230 is in the first position. The monitor component 1010 can provide, to the interface 1020, the position of the surface 230. The interface 1020 can display, via a user interface, the position of the surface 230.

The monitor component 1010 can receive, via the interface 1020, a request to move the surface 230. The request can be an operator of the vehicle 105 or the apparatus 205 selecting an icon, displayed on the interface 1020, to move the surface 230. The monitor component 1010 can, responsive to receiving the request to move the surface 230, can communicate with, interact with or otherwise interface with the controller 1015.

The controller 1015 can receive, form the monitor component 1010, an indication to move the surface 230. The controller 1015 can, responsive to receiving the indication to move the surface 230, communicate with, interface face with or otherwise interact with the rotating mechanism 245. For example, the controller 1015 can send a signal, to the rotating mechanism 245, that releases the rotating mechanism 245 (similar to that of the button described herein), and the operator of the vehicle 105, or the apparatus 205 can, responsive to the controller 1015 sending the signal to the rotating mechanism 245, can interface with, interact with or otherwise engage the rotating mechanism 245 to move the surface 230.

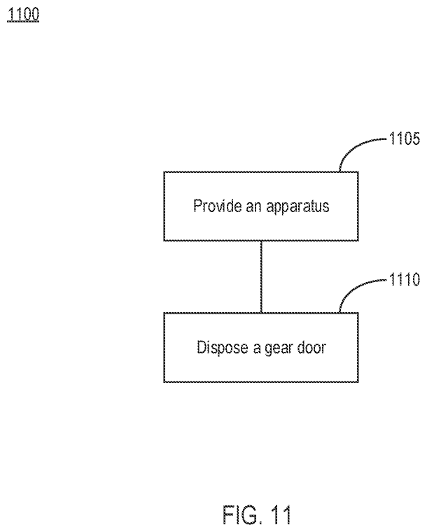

FIG. 11 is a flow diagram of a process 1100 where an apparatus can be provided, in accordance with an implementation. In ACT 1105, an apparatus can be provided. The apparatus can be the apparatus 205. The apparatus 205 can be provided to a vehicle (e.g., the vehicle 105). The apparatus 205 can be provided during the manufacturing process of the vehicle 105. The apparatus 205 can be provided after the vehicle 105 has been purchased. For example, the apparatus 205 can be provided after the owner of the vehicle 105 purchases the apparatus 205 and the owner then takes the vehicle 105 to a shop that can then provide the apparatus 205. The owner of the vehicle 105 can provide the apparatus 205 on their own. For example, the owner of the vehicle 105 can provide the apparatus 205 upon purchasing the apparatus 205. The apparatus 205 can include a gear door (e.g., the gear door 210).

In ACT 1110, a gear door can be disposed. The gear door can be the gear door 210. The gear door 210 can disposed at least partially between the rear wheel 215 and the rear gate 220. The gear door 210 can be disposed at least partially between the rear wheel 215 and the rear gate 220 responsive to the gear door 210 being placed, positioned, mounted, attached, secured or otherwise coupled, with the vehicle 105, at least partially between the rear wheel 215 and the rear gate 220.

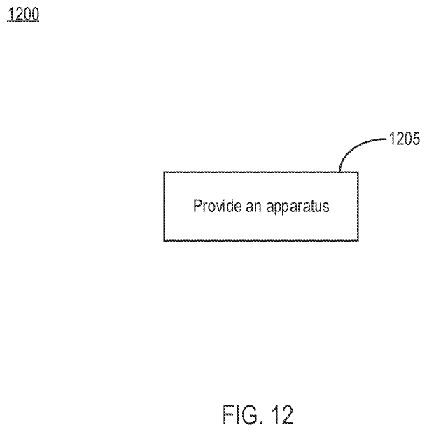

FIG. 12 is a flow diagram of a process 1200 where an apparatus can be provided. In ACT 1205, an apparatus can be provided. The apparatus can be the apparatus 205. The apparatus 205 can be provided to a vehicle (e.g., the vehicle 105). The apparatus 205 can be provided during the manufacturing process of the vehicle 105. The apparatus 205 can be provided after the vehicle 105 has been purchased. For example, the apparatus 205 can be provided after the owner of the vehicle 105 purchases the apparatus 205 and the owner then takes the vehicle 105 to a shop that can then provide the apparatus 205. The owner of the vehicle 105 can provide the apparatus 205 on their own. For example, the owner of the vehicle 105 can provide the apparatus 205 upon purchasing the apparatus 205. The apparatus 205 can include a gear door (e.g., the gear door 210).

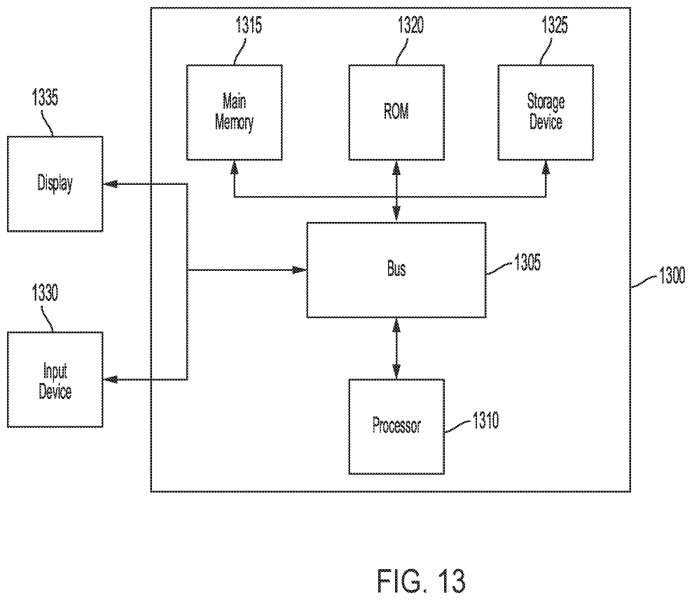

FIG. 13 depicts an example block diagram of an example computer system 1300. The computer system or computing device 1300 can include or be used to implement a data processing system or its components. The computing system 1300 includes at least one bus 1305 or other communication component for communicating information and at least one processor 1310 or processing circuit coupled to the bus 1305 for processing information. The computing system 1300 can also include one or more processors 1310 or processing circuits coupled to the bus for processing information. The computing system 1300 also includes at least one main memory 1315, such as a random access memory (RAM) or other dynamic storage device, coupled to the bus 1305 for storing information, and instructions to be executed by the processor 1310. The main memory 1315 can be used for storing information during execution of instructions by the processor 1310. The computing system 1300 may further include at least one read only memory (ROM) 1320 or other static storage device coupled to the bus 1305 for storing static information and instructions for the processor 1310. A storage device 1325, such as a solid state device, magnetic disk or optical disk, can be coupled to the bus 1305 to persistently store information and instructions.

The computing system 1300 may be coupled via the bus 1305 to a display 1335, such as a liquid crystal display, or active matrix display, for displaying information to a user such as a driver of the electric vehicle 105 or other end user. An input device 1330, such as a keyboard or voice interface may be coupled to the bus 1305 for communicating information and commands to the processor 1310. The input device 1330 can include a touch screen display 1335. The input device 1330 can also include a cursor control, such as a mouse, a trackball, or cursor direction keys, for communicating direction information and command selections to the processor 1310 and for controlling cursor movement on the display 1335.

The processes, systems and methods described herein can be implemented by the computing system 1300 in response to the processor 1310 executing an arrangement of instructions contained in main memory 1315. Such instructions can be read into main memory 1315 from another computer-readable medium, such as the storage device 1325. Execution of the arrangement of instructions contained in main memory 1315 causes the computing system 1300 to perform the illustrative processes described herein. One or more processors in a multi-processing arrangement may also be employed to execute the instructions contained in main memory 1315. Hard-wired circuitry can be used in place of or in combination with software instructions together with the systems and methods described herein. Systems and methods described herein are not limited to any specific combination of hardware circuitry and software.

Although an example computing system has been described in FIG. 13, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, compromising:
a gear door disposed at least partially between a rear wheel of a vehicle and a rear gate of the vehicle;
the gear door configured to move from a closed position to an open position to provide access to an internal portion of the vehicle in the open position; and
the gear door having a surface to support an object with the gear door in the open position.

2. The apparatus of claim 1, comprising:
a locking mechanism configured to lock the gear door in the closed position; and
an arm, coupled with the vehicle, configured to move the gear door from the closed position to the open position; and
the arm configured to prevent the gear door from making contact with an external portion of the vehicle with the gear door in the open position.

3. The apparatus of claim 1, comprising:
the gear door including:
a handle configured to actuate a locking mechanism from a first position to a second position;
the gear door configured to move, responsive to actuation of the locking mechanism from the first position to the second position, from the closed position to a third position away from the vehicle; and
the gear door configured to move, responsive to an external force, from the third position to the open position.

4. The apparatus of claim 1, comprising:
wherein a portion of the apparatus rests on a structure of the vehicle with the gear door in the open position;
wherein the portion of the apparatus resting on the structure of the vehicle defines the open position.

5. The apparatus of claim 1, comprising:
the vehicle including:
a data processing system, the data processing system comprising at least one processor, coupled with memory, to:
receive, via a graphical user interface, an indication to unlock the gear door; and
unlock, responsive to receiving the indication, the gear door;
wherein, responsive to unlocking the gear door, at least a portion of the gear door moves away from the vehicle.

6. The apparatus of claim 1, comprising:
the vehicle including:
a data processing system, the data processing system comprising at least one processor, coupled with memory, to:
detect a position of the gear door;
determine that the position of the gear door is not within a predetermined position; and
provide, to a graphical user interface, responsive to determining that the gear door is not within the predetermined position, an alert indicating the position of the gear door.

7. The apparatus of claim 1, comprising:
the vehicle including:
a data processing system, the data processing system comprising at least one processor, coupled with memory, to:
receive, via a graphical user interface, a request to lock the gear door;
determine a position of the gear door;
provide, via the graphical user interface, an alert indicating that the gear door is not in the closed position;
determine a second position of the gear door; and
lock, responsive to determining that the second position is the closed position, the gear door in the closed position.

8. The apparatus of claim 1, comprising:
the gear door including:
a housing, disposed beneath the surface, configured to store at least one component; and
the surface including:
a hinge configured to move the surface from a first position to a second position;
wherein the housing is covered with the surface in the first position;
wherein the housing is accessible with the surface in the second position.

9. The apparatus of claim 1, comprising:
a partition configured to divide the internal portion of the vehicle, wherein the gear door and the partition form a cavity that is smaller than the internal portion of the vehicle; and
the cavity configured to receive and store a component.

10. The apparatus of claim 1, comprising:
a first portion including the surface, the first portion having a first distance from a ground surface; and
a second portion coupled with the vehicle, the second portion having a second distance from the ground surface;
wherein the first distance is smaller than the second distance with the gear door in the open position;
wherein the first distance is larger than the second distance with the gear door in the closed position.

11. The apparatus of claim 1, comprising:
the gear door including a first orientation with the gear door in the open position; and
a portion of the vehicle including a second orientation;
wherein the first orientation and the second orientation are different;
wherein the first orientation and the second orientation define an angle that is different than 90 degrees.

12. The apparatus of claim 1, comprising:
the gear door including:
a rotating mechanism configured to rotate the surface from a first position to a second position; and
an adjusting mechanism configured to adjust the surface from a first height to a second height.

13. The apparatus of claim 1, wherein the internal portion of the vehicle is at least one of a cabin, a trunk or a storage compartment.

14. A vehicle, comprising:
a rear wheel;
a rear gate; and
an apparatus, including:
a gear door disposed at least partially between the rear wheel and the rear gate;
the gear door configured to move from a closed position to an open position to provide access to an internal portion of the vehicle in the open position; and
the gear door having a surface to support an object with the gear door in the open position.

15. The vehicle of claim 14, comprising:
the apparatus including:
a locking mechanism configured to lock the gear door in the closed position; and
an arm, coupled with the vehicle, configured to move the gear door from the closed position to the open position; and
the arm configured to prevent the gear door from making contact with an external portion of the vehicle with the gear door in the open position.

16. The vehicle of claim 14, comprising:
the gear door including:
a handle configured to actuate a locking mechanism from a first position to a second position;
the gear door configured to move, responsive to actuation of the locking mechanism from the first position to the second position, from the closed position to a third position away from the vehicle; and
the gear door configured to move, responsive to an external force, from the third position to the open position.

17. The vehicle of claim 14, comprising:
a data processing system, the data processing system comprising at least one processor, coupled with memory, to:
receive, via a graphical user interface, an indication to unlock the gear door; and
unlock, responsive to receiving the indication, the gear door;
wherein, responsive to unlocking the gear door, at least a portion of the gear door moves away from the vehicle.

18. The vehicle of claim 14, comprising:
the apparatus including:
a partition configured to divide the internal portion of the vehicle, wherein the gear door, and the partition form a cavity that is smaller than the internal portion of the vehicle; and
the cavity configured to receive and store a component.

19. A method, comprising:
providing an apparatus, the apparatus including a gear door;
disposing the gear door at least partially between a rear wheel of a vehicle and a rear gate of the vehicle;
the gear door configured to move from a closed position to an open position to provide access to an internal portion of the vehicle in the open position; and
the gear door having a surface to support an object with the gear door in the open position.

20. The method of claim 19, comprising:
dividing, by a partition, the internal portion of the vehicle;
forming, by the gear door, and the partition, a cavity that is smaller than the internal portion of the vehicle, the cavity configured to receive and store a component.
